(19) United States
(12) Patent Application Publication
(10) Pub. No.: US 2014/0192881 A1
(43) Pub. Date: Jul. 10, 2014

(54) VIDEO PROCESSING SYSTEM WITH TEMPORAL PREDICTION MECHANISM AND METHOD OF OPERATION THEREOF

(71) Applicant: SONY CORPORATION, Tokyo (JP)

(72) Inventors: Jun Xu, Sunnyvale, CA (US); Ali Tabatabai, Cupertino, CA (US); Kazushi Sato, Yokohama Kanagawa (JP)

(73) Assignee: SONY CORPORATION, Tokyo (JP)

(21) Appl. No.: 14/053,256

(22) Filed: Oct. 14, 2013

Related U.S. Application Data
(60) Provisional application No. 61/749,680, filed on Jan. 7, 2013.

(51) Int. Cl. H04N 7/36

(52) U.S. Cl. CPC H04N 19/00696
USPC 375/240.16

(57) ABSTRACT

A video processing system, and a method of operation thereof, including: a source input module for receiving a frame from a video source; and a picture process module, coupled to the source input module, for encoding the frame with an inter-layer motion vector prediction by generating a base motion vector of a base layer and an enhancement motion vector of an enhancement layer based on the base motion vector to eliminate a storage capacity for an enhancement temporal motion vector in the enhancement layer and for generating a video bitstream based on the base motion vector and the enhancement motion vector for a video decoder to receive and decode for displaying on a device.

### CROSS-REFERENCE TO RELATED APPLICATION(S)

This application claims the benefit of U.S. Provisional Patent Application Ser. No. 61/749,680 filed Jan. 7, 2013, and the subject matter thereof is incorporated herein by reference thereto.

### TECHNICAL FIELD

The present invention relates generally to a video processing system and more particularly to a system for temporal prediction mechanism.

### BACKGROUND ART

The deployment of high quality video to smart phones, high definition televisions, automotive information systems, and other video devices with screens has grown tremendously in recent years. The wide variety of information devices supporting video content requires multiple types of video content to be provided to devices with different size, quality, and connectivity capabilities.

Video has evolved from two dimensional single view video to multi-view video with high-resolution three-dimensional imagery. In order to make the transfer of video more efficient, different video coding and compression schemes have tried to get the best picture from the least amount of data.

The Moving Pictures Experts Group (MPEG) developed standards to allow good video quality based on a standardized data sequence and algorithm. The MPEG4 Part 10 (H.264)/Advanced Video Coding design was an improvement in coding efficiency typically by a factor of two over the prior MPEG-2 format.

The quality of the video is dependent upon the manipulation and compression of the data in the video. The video can be modified to accommodate the varying bandwidths used to send the video to the display devices with different resolutions and feature sets. However, distributing larger, higher quality video or more complex video functionality requires additional bandwidth and improved video compression.

Thus, a need still remains for a video processing system that can deliver good picture quality and features across a wide range of device with different sizes, resolutions, and connectivity. In view of the increasing demand for providing video on the growing spectrum of intelligent devices, it is increasingly critical that answers be found to these problems. In view of the ever-increasing commercial competitive pressures, along with growing consumer expectations and the diminishing opportunities for meaningful product differentiation in the marketplace, it is critical that answers be found for these problems. Additionally, the need to reduce costs, improve efficiencies and performance, and meet competitive pressures adds an even greater urgency to the critical necessity for finding answers to these problems.

Solutions to these problems have been long sought but prior developments have not taught or suggested any solutions and, thus, solutions to these problems have long eluded those skilled in the art.

### DISCLOSURE OF THE INVENTION

The present invention provides a method of operation of a video processing system, including: receiving a frame from a video source; encoding the frame with an inter-layer motion vector prediction by generating a base motion vector of a base layer and an enhancement motion vector of an enhancement layer based on the base motion vector to eliminate a storage capacity for an enhancement temporal motion vector in the enhancement layer; and generating a video bitstream based on the base motion vector and the enhancement motion vector for a video decoder to receive and decode for displaying on a device.

The present invention provides a video processing system, including: a source input module for receiving a frame from a video source; and a picture process module, coupled to the source input module, for encoding the frame with an inter-layer motion vector prediction by generating a base motion vector of a base layer and an enhancement motion vector of an enhancement layer based on the base motion vector to eliminate a storage capacity for an enhancement temporal motion vector in the enhancement layer and for generating a video bitstream based on the base motion vector and the enhancement motion vector for a video decoder to receive and decode for displaying on a device.

Certain embodiments of the invention have other steps or elements in addition to or in place of those mentioned above. The steps or elements will become apparent to those skilled in the art from a reading of the following detailed description when taken with reference to the accompanying drawings.

### BRIEF DESCRIPTION OF THE DRAWINGS

FIG. 1 is a system diagram of a video processing system in an embodiment of the present invention.

FIG. 2 is an example of the video bitstream.

FIG. 3 is an example of a coding tree unit.

FIG. 4 is an example of prediction units.

FIG. 5 is a hardware diagram of the video processing system.

FIG. 6 is an exemplary diagram illustrating an inter-layer motion vector prediction.

FIG. 7 is an example of a sequence parameter set syntax.

FIG. 8 is an example of a slice segment header syntax.

FIG. 9 is a control flow for a temporal motion vector control process.

FIG. 10 is a flow chart of a method of operation of a video processing system in a further embodiment of the present invention.

### BEST MODE FOR CARRYING OUT THE INVENTION

The following embodiments are described in sufficient detail to enable those skilled in the art to make and use the invention. It is to be understood that other embodiments would be evident based on the present disclosure, and that system, process, or mechanical changes may be made without departing from the scope of the present invention.

In the following description, numerous specific details are given to provide a thorough understanding of the invention. However, it will be apparent that the invention may be practiced without these specific details. In order to avoid obscuring the present invention, some well-known circuits, system configurations, and process steps are not disclosed in detail.

The drawings showing embodiments of the system are semi-diagrammatic and not to scale and, particularly, some of the dimensions are for the clarity of presentation and are shown exaggerated in the drawing FIGs.

Where multiple embodiments are disclosed and described having some features in common, for clarity and ease of illustration, description, and comprehension thereof, similar and like features one to another will ordinarily be described with similar reference numerals. The embodiments have been numbered first embodiment, second embodiment, etc. as a matter of descriptive convenience and are not intended to have any other significance or provide limitations for the present invention.

The term “module” referred to herein can include software, hardware, or a combination thereof in the present invention in accordance with the context in which the term is used. For example, the software can be machine code, firmware, embedded code, and application software. Also for example, the hardware can be circuitry, processor, computer, integrated circuit, integrated circuit cores, a microelectromechanical system (MEMS), passive devices, environmental sensors including temperature sensors, or a combination thereof.

The term “syntax” referred to herein means a set of elements describing a data structure. The term “block” referred to herein means a group of picture elements, pixels, or smallest addressable elements in a display device.

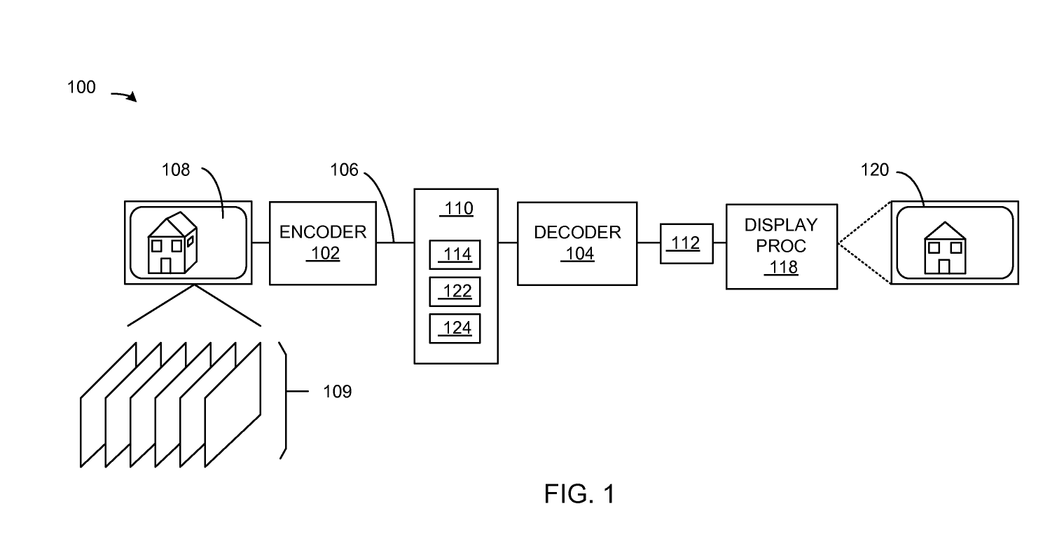

Referring now to FIG. 1, therein is shown a system diagram of a video processing system 100 in an embodiment of the present invention. The video processing system 100 can encode and decode video information. A video encoder 102 can receive a video source 108 and send a video bitstream 110 to a video decoder 104 for decoding and displaying on a display interface 120.

The video encoder 102 can receive and encode the video source 108. The video encoder 102 is a unit for encoding the video source 108 into a different form. The video source 108 is defined as a digital representation of a scene of objects.

Encoding is defined as computationally modifying the video source 108 to a different form. For example, encoding can compress the video source 108 into the video bitstream 110 to reduce the amount of data needed to transmit the video bitstream 110.

In another example, the video source 108 can be encoded by being compressed, visually enhanced, separated into one or more views, changed in resolution, changed in aspect ratio, or a combination thereof. In another illustrative example, the video source 108 can be encoded according to the High-Efficiency Video Coding (HEVC)/H.265 standard. In yet another illustrative example, the video source 108 can be further encoded to increase spatial scalability.

The video source 108 can include frames 109. The frames 109 are individual images that form the video source 108. For example, the video source 108 can be the digital output of one or more digital video cameras taking any number including 24 of the frames 109 per second.

The video encoder 102 can encode the video source 108 to form the video bitstream 110. The video bitstream 110 is defined a sequence of bits representing information associated with the video source 108. For example, the video bitstream 110 can be a bit sequence representing a compression of the video source 108.

In an illustrative example, the video bitstream 110 can be a serial bitstream sent from the video encoder 102 to the video decoder 104. In another illustrative example, the video bitstream 110 can be a data file stored on a storage device and retrieved for use by the video decoder 104.

The video encoder 102 can receive the video source 108 for a scene in a variety of ways. For example, the video source 108 representing objects in the real world can be captured with a video camera, multiple cameras, generated with a computer, provided as a file, or a combination thereof.

The video source 108 can include a variety of video features. For example, the video source 108 can include single view video, multiview video, stereoscopic video, or a combination thereof.

The video encoder 102 can encode the video source 108 using a video syntax 114 to generate the video bitstream 110. The video syntax 114 is defined as a set of information elements that describe a coding system for encoding and decoding the video source 108.

The video bitstream 110 is compliant with the video syntax 114, including High-Efficiency Video Coding/H.265. For example, the video syntax 114 can include a HEVC video bitstream, an Ultra High Definition video bitstream, or a combination thereof. The video bitstream 110 can include the video syntax 114.

The video bitstream 110 can include information representing the imagery of the video source 108 and the associated control information related to the encoding of the video source 108. For example, the video bitstream 110 can include an occurrence of the video syntax 114 and an occurrence of the video source 108.

The video encoder 102 can encode the frames 109 in the video source 108 to form a base layer 122 (BL) and enhancement layers 124 (EL). The base layer 122 is a representation of the video source 108. For example, the base layer 122 can include the video source 108 at a different resolution, quality, bit rate, frame rate, or a combination thereof.

The base layer 122 can be a lower resolution representation of the video source 108. In another example, the base layer 122 can be a High Efficiency Video Coding (HEVC) representation of the video source 108. In yet another example, the base layer 122 can be a representation of the video source 108 configured for a smart phone display.

The enhancement layers 124 are representations of the video source 108 based on the video source 108 and the base layer 122. The enhancement layers 124 can be higher quality representations of the video source 108 at different resolutions, quality, bit rates, frame rates, or a combination thereof. The enhancement layers 124 can be higher resolution representations of the video source 108 than the base layer 122.

The video processing system 100 can include the video decoder 104 for decoding the video bitstream 110. The video decoder 104 is defined as a unit for receiving the video bitstream 110 and modifying the video bitstream 110 to form a video stream 112.

The video decoder 104 can decode the video bitstream 110 to form the video stream 112 using the video syntax 114. Decoding is defined as computationally modifying the video bitstream 110 to form the video stream 112. For example, decoding can decompress the video bitstream 110 to form the video stream 112 formatted for displaying on the display the display interface 120.

The video stream 112 is defined as a computationally modified version of the video source 108. For example, the video stream 112 can include a modified occurrence of the video source 108 with different resolution. The video stream 112 can include cropped decoded pictures from the video source 108.

The video decoder 104 can form the video stream 112 in a variety of ways. For example, the video decoder 104 can form the video stream 112 from the base layer 122. In another example, the video decoder 104 can form the video stream 112 from the base layer 122 and one or more of the enhancement layers 124.

In a further example, the video stream 112 can have a different aspect ratio, a different frame rate, different stereoscopic views, different view order, or a combination thereof than the video source 108. The video stream 112 can have different visual properties including different color parameters, color planes, contrast, hue, or a combination thereof.

The video processing system 100 can include a display processor 118. The display processor 118 can receive the video stream 112 from the video decoder 104 for displaying on the display interface 120. The display interface 120 is a unit that can present a visual representation of the video stream 112.

For example, the display interface 120 can include a smart phone display, a digital projector, a DVD player display, or a combination thereof. Although the video processing system 100 shows the video decoder 104, the display processor 118, and the display interface 120 as individual units, it is understood that the video decoder 104 can include the display processor 118 and the display interface 120.

The video encoder 102 can send the video bitstream 110 to the video decoder 104 in a variety of ways. For example, the video encoder 102 can send the video bitstream 110 to the video decoder 104 over a communication path 106. In another example, the video encoder 102 can send the video bitstream 110 as a data file on a storage device. The video decoder 104 can access the data file to receive the video bitstream 110.

The communication path 106 can be a variety of networks suitable for data transfer. For example, the communication path 106 can include wireless communication, wired communication, optical, infrared, or the combination thereof.

Satellite communication, cellular communication, terrestrial communication, Bluetooth, Infrared Data Association standard (IrDA), wireless fidelity (WiFi), and worldwide interoperability for microwave access (WiMAX) are examples of wireless communication that can be included in the communication path 106. Ethernet, digital subscriber line (DSL), fiber to the home (FTTH), digital television, and plain old telephone service (POTS) are examples of wired communication that can be included in the communication path 106.

The video processing system 100 can employ a variety of video coding syntax structures. For example, the video processing system 100 can encode and decode video information using High Efficiency Video Coding/H.265 (HEVC), scalable extensions for HEVC, or other video coding syntax structures.

The video encoder 102 and the video decoder 104 can be implemented in a variety of ways. For example, the video encoder 102 and the video decoder 104 can be implemented using hardware, software, or a combination thereof. For example, the video encoder 102 can be implemented with custom circuitry, a digital signal processor, microprocessor, or a combination thereof. In another example, the video decoder 104 can be implemented with custom circuitry, a digital signal processor, microprocessor, or a combination thereof.

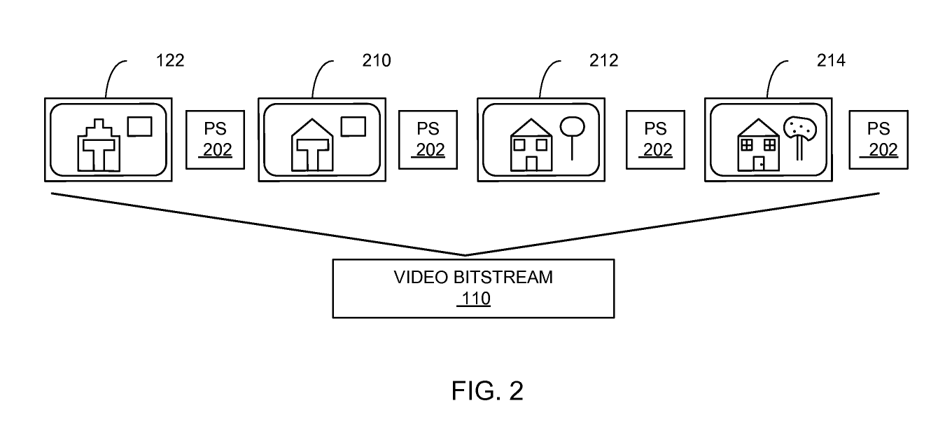

Referring now to FIG. 2, therein is shown an example of the video bitstream 110. The video bitstream 110 includes an encoded occurrence of the video source 108 of FIG. 1 and can be decoded to form the video stream 112 of FIG. 1 for displaying on the display interface 120 of FIG. 1. The video bitstream 110 can include the base layer 122 and the enhancement layers 124 based on the video source 108.

The video bitstream 110 can include one of the frames 109 of FIG. 1 of the base layer 122 followed by a parameter set 202 associated with the base layer 122. The video bitstream 110 can include the frames 109 of the enhancement layers 124.

For example, the enhancement layers 124 can include the frames 109 from a first enhancement layer 210, a second enhancement layer 212, and a third enhancement layer 214. Each of the frames 109 of the enhancement layers 124 can be followed by the parameter set 202 associated with one of the enhancement layers 124.

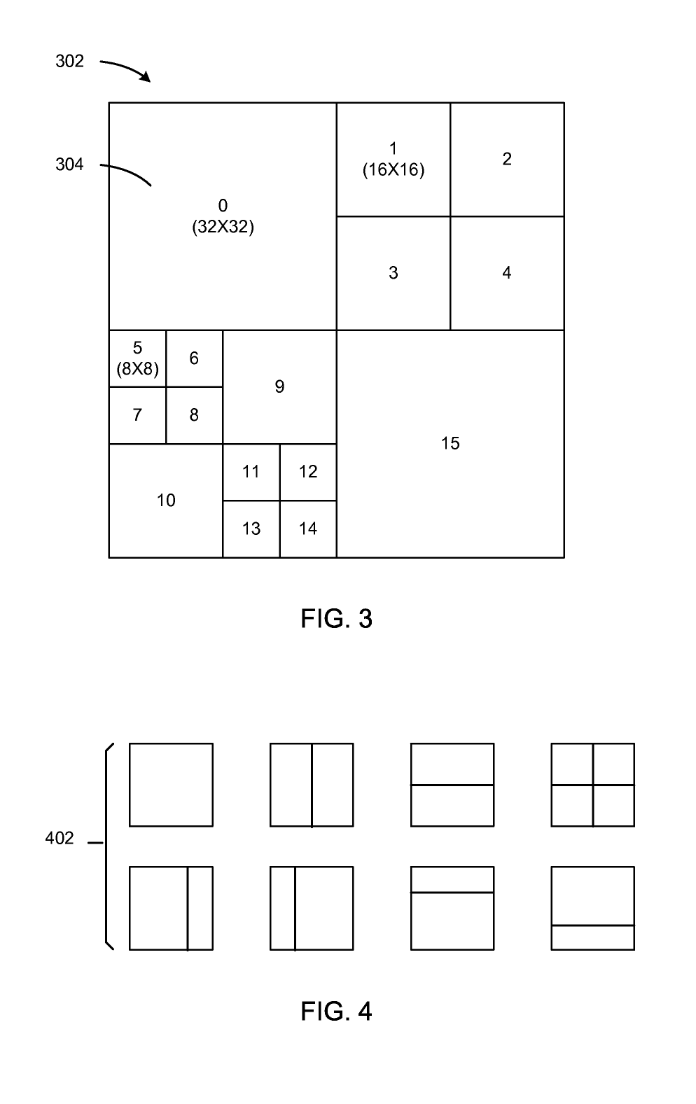

Referring now to FIG. 3, therein is shown an example of a coding tree unit 302. The coding tree unit 302 is a basic unit of video coding.

The video source 108 of FIG. 1 can include the frames 109 of FIG. 1. Each of the frames 109 can be encoded into the coding tree unit 302.

The coding tree unit 302 can be subdivided into coding units 304 using a quadtree structure. The quadtree structure is a tree data structure in which each internal mode has exactly four children. The quadtree structure can partition a two dimensional space by recursively subdividing the space into four quadrants.

The frames 109 of the video source 108 can be subdivided into the coding units 304. The coding units 304 are square regions that make up one of the frames 109 of the video source 108.

The coding units 304 can be a variety of sizes. For example, the coding units 304 can be up to 64×64 pixels in size. Each of the coding units 304 can be recursively subdivided into four more of smaller units with sizes smaller than those of the coding units 304. In another example, the coding units 304 having 64×64 pixels can include the smaller units having 32×32 pixels, 16×16 pixels, or 8×8 pixels.

Referring now to FIG. 4, therein is shown an example of prediction units 402. The prediction units 402 are regions within the coding units 304 of FIG. 3. The contents of the prediction units 402 can be calculated based on the content of other adjacent regions of pixels. The prediction units 402 can include the smaller units previously described.

Each of the prediction units 402 can be calculated in a variety of ways. For example, the prediction units 402 can be calculated using intra-prediction or inter-prediction.

The prediction units 402 calculated using intra-prediction can include content based on neighboring regions. For example, the content of the prediction units 402 can be calculated using an average value, by fitting a plan surface to one of the prediction units 402, direction prediction extrapolated from neighboring regions, or a combination thereof.

The prediction units 402 calculated using inter-prediction can include content based on image data from the frames 109 of FIG. 1 that are nearby. For example, the content of the prediction units 402 can include content calculated using previous frames or later frames, content based on motion compensated predictions, average values from multiple frames, or a combination thereof.

The prediction units 402 can be formed by partitioning one of the coding units 304 in one of eight partition modes. The coding units 304 can include one, two, or four of the prediction units 402. The prediction units 402 can be rectangular or square.

For example, the prediction units 402 can be represented by mnemonics 2N×2N, 2N×N, N×2N, N×N, 2N×nU, 2N×nD, nL×2N, and nR×2N. Uppercase “N” can represent half the length of one of the coding units 304. Lowercase “n” can represent one quarter of the length of one of the coding units 304. Uppercases “R” and “L” can represent right or left respectively. Uppercase “U” and “D” can represent up and down respectively.

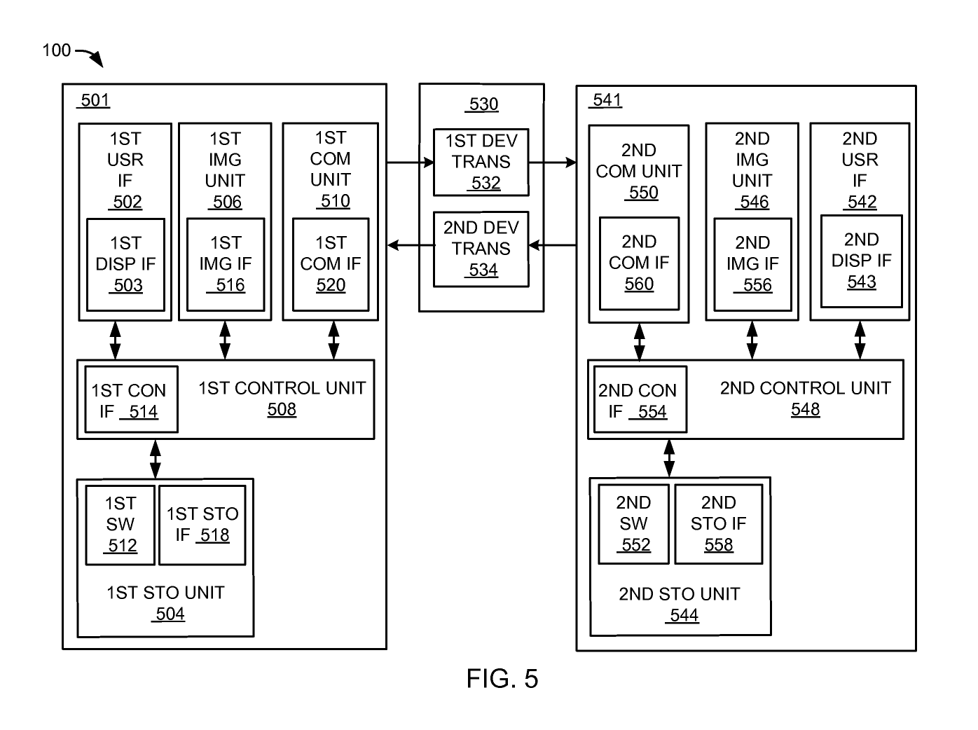

Referring now to FIG. 5, therein is shown a hardware diagram of the video processing system 100. The video processing system 100 can include a first device 501, a second device 541, and a communication link 530.

The video processing system 100 can be implemented using the first device 501, the second device 541, and the communication link 530. For example, the first device 501 can implement the video encoder 102 of FIG. 1, the second device 541 can implement the video decoder 104 of FIG. 1, and the communication link 530 can implement the communication path 106 of FIG. 1. However, it is understood that the video processing system 100 can be implemented in a variety of ways and the functionality of the video encoder 102, the video decoder 104, and the communication path 106 can be partitioned differently over the first device 501, the second device 541, and the communication link 530.

The first device 501 can communicate with the second device 541 over the communication link 530. The first device 501 can send information in a first device transmission 532 over the communication link 530 to the second device 541. The second device 541 can send information in a second device transmission 534 over the communication link 530 to the first device 501.

For illustrative purposes, the video processing system 100 is shown with the first device 501 as a client device, although it is understood that the video processing system 100 can have the first device 501 as a different type of device. For example, the first device can be a server. In a further example, the first device 501 can be the video encoder 102, the video decoder 104, or a combination thereof.

Also for illustrative purposes, the video processing system 100 is shown with the second device 541 as a server, although it is understood that the video processing system 100 can have the second device 541 as a different type of device. For example, the second device 541 can be a client device. In a further example, the second device 541 can be the video encoder 102, the video decoder 104, or a combination thereof.

For brevity of description in this embodiment of the present invention, the first device 501 will be described as a client device, such as a video camera, smart phone, or a combination thereof. The present invention is not limited to this selection for the type of devices. The selection is an example of the present invention.

The first device 501 can include a first control unit 508. The first control unit 508 can include a first control interface 514. The first control unit 508 can execute a first software 512 to provide the intelligence of the video processing system 100.

The first control unit 508 can be implemented in a number of different manners. For example, the first control unit 508 can be a processor, an embedded processor, a microprocessor, a hardware control logic, a hardware finite state machine (FSM), a digital signal processor (DSP), or a combination thereof.

The first control interface 514 can be used for communication between the first control unit 508 and other functional units in the first device 501. The first control interface 514 can also be used for communication that is external to the first device 501.

The first control interface 514 can receive information from the other functional units or from external sources, or can transmit information to the other functional units or to external destinations. The external sources and the external destinations refer to sources and destinations external to the first device 501.

The first control interface 514 can be implemented in different ways and can include different implementations depending on which functional units or external units are being interfaced with the first control interface 514. For example, the first control interface 514 can be implemented with electrical circuitry, microelectromechanical systems (MEMS), optical circuitry, wireless circuitry, wireline circuitry, or a combination thereof.

The first device 501 can include a first storage unit 504. The first storage unit 504 can store the first software 512. The first storage unit 504 can also store the relevant information, such as images, syntax information, video, profiles, display preferences, sensor data, or any combination thereof.

The first storage unit 504 can be a volatile memory, a nonvolatile memory, an internal memory, an external memory, or a combination thereof. For example, the first storage unit 504 can be a nonvolatile storage such as non-volatile random access memory (NVRAM), Flash memory, disk storage, or a volatile storage such as static random access memory (SRAM).

The first storage unit 504 can include a first storage interface 518. The first storage interface 518 can be used for communication between the first storage unit 504 and other functional units in the first device 501. The first storage interface 518 can also be used for communication that is external to the first device 501.

The first device 501 can include a first imaging unit 506. The first imaging unit 506 can capture the video source 108 of FIG. 1 from the real world. The first imaging unit 506 can include a digital camera, a video camera, an optical sensor, or any combination thereof.

The first imaging unit 506 can include a first imaging interface 516. The first imaging interface 516 can be used for communication between the first imaging unit 506 and other functional units in the first device 501.

The first imaging interface 516 can receive information from the other functional units or from external sources, or can transmit information to the other functional units or to external destinations. The external sources and the external destinations refer to sources and destinations external to the first device 501.

The first imaging interface 516 can include different implementations depending on which functional units or external units are being interfaced with the first imaging unit 506. The first imaging interface 516 can be implemented with technologies and techniques similar to the implementation of the first control interface 514.

The first storage interface 518 can receive information from the other functional units or from external sources, or can transmit information to the other functional units or to external destinations. The external sources and the external destinations refer to sources and destinations external to the first device 501.

The first storage interface 518 can include different implementations depending on which functional units or external units are being interfaced with the first storage unit 504. The first storage interface 518 can be implemented with technologies and techniques similar to the implementation of the first control interface 514.

The first device 501 can include a first communication unit 510. The first communication unit 510 can be for enabling external communication to and from the first device 501. For example, the first communication unit 510 can permit the first device 501 to communicate with the second device 541, an attachment, such as a peripheral device or a computer desktop, and the communication link 530.

The first communication unit 510 can also function as a communication hub allowing the first device 501 to function as part of the communication link 530 and not limited to be an end point or terminal unit to the communication link 530. The first communication unit 510 can include active and passive components, such as microelectronics or an antenna, for interaction with the communication link 530.

The first communication unit 510 can include a first communication interface 520. The first communication interface 520 can be used for communication between the first communication unit 510 and other functional units in the first device 501. The first communication interface 520 can receive information from the other functional units or can transmit information to the other functional units.

The first communication interface 520 can include different implementations depending on which functional units are being interfaced with the first communication unit 510. The first communication interface 520 can be implemented with technologies and techniques similar to the implementation of the first control interface 514.

The first device 501 can include a first user interface 502. The first user interface 502 allows a user (not shown) to interface and interact with the first device 501. The first user interface 502 can include a first user input (not shown). The first user input can include touch screen, gestures, motion detection, buttons, slicers, knobs, virtual buttons, voice recognition controls, or any combination thereof.

The first user interface 502 can include the first display interface 503. The first display interface 503 can allow the user to interact with the first user interface 502. The first display interface 503 can include a display, a video screen, a speaker, or any combination thereof.

The first control unit 508 can operate with the first user interface 502 to display video information generated by the video processing system 100 on the first display interface 503. The first control unit 508 can also execute the first software 512 for the other functions of the video processing system 100, including receiving video information from the first storage unit 504 for displaying on the first display interface 503. The first control unit 508 can further execute the first software 512 for interaction with the communication link 530 via the first communication unit 510.

For illustrative purposes, the first device 501 can be partitioned having the first user interface 502, the first storage unit 504, the first control unit 508, and the first communication unit 510, although it is understood that the first device 501 can have a different partition. For example, the first software 512 can be partitioned differently such that some or all of its function can be in the first control unit 508 and the first communication unit 510. In addition, the first device 501 can include other functional units not shown in FIG. 1 for clarity.

The video processing system 100 can include the second device 541. The second device 541 can be optimized for implementing the present invention in a multiple device embodiment with the first device 501. The second device 541 can provide the additional or higher performance processing power compared to the first device 501.

The second device 541 can include a second control unit 548. The second control unit 548 can include a second control interface 554. The second control unit 548 can execute a second software 552 to provide the intelligence of the video processing system 100.

The second control unit 548 can be implemented in a number of different manners. For example, the second control unit 548 can be a processor, an embedded processor, a microprocessor, a hardware control logic, a hardware finite state machine (FSM), a digital signal processor (DSP), or a combination thereof.

The second control interface 554 can be used for communication between the second control unit 548 and other functional units in the second device 541. The second control interface 554 can also be used for communication that is external to the second device 541.

The second control interface 554 can receive information from the other functional units or from external sources, or can transmit information to the other functional units or to external destinations. The external sources and the external destinations refer to sources and destinations external to the second device 541.

The second control interface 554 can be implemented in different ways and can include different implementations depending on which functional units or external units are being interfaced with the second control interface 554. For example, the second control interface 554 can be implemented with electrical circuitry, microelectromechanical systems (MEMS), optical circuitry, wireless circuitry, wireline circuitry, or a combination thereof.

The second device 541 can include a second storage unit 544. The second storage unit 544 can store the second software 552. The second storage unit 544 can also store the relevant information, such as images, syntax information, video, profiles, display preferences, sensor data, or any combination thereof.

The second storage unit 544 can be a volatile memory, a nonvolatile memory, an internal memory, an external memory, or a combination thereof. For example, the second storage unit 544 can be a nonvolatile storage such as non-volatile random access memory (NVRAM), Flash memory, disk storage, or a volatile storage such as static random access memory (SRAM).

The second storage unit 544 can include a second storage interface 558. The second storage interface 558 can be used for communication between the second storage unit 544 and other functional units in the second device 541. The second storage interface 558 can also be used for communication that is external to the second device 541.

The second storage interface 558 can receive information from the other functional units or from external sources, or can transmit information to the other functional units or to external destinations. The external sources and the external destinations refer to sources and destinations external to the second device 541.

The second storage interface 558 can include different implementations depending on which functional units or external units are being interfaced with the second storage unit 544. The second storage interface 558 can be implemented with technologies and techniques similar to the implementation of the second control interface 554.

The second device 541 can include a second imaging unit 546. The second imaging unit 546 can capture the video source 108 from the real world. The first imaging unit 506 can include a digital camera, a video camera, an optical sensor, or any combination thereof.

The second imaging unit 546 can include a second imaging interface 556. The second imaging interface 556 can be used for communication between the second imaging unit 546 and other functional units in the second device 541.

The second imaging interface 556 can receive information from the other functional units or from external sources, or can transmit information to the other functional units or to external destinations. The external sources and the external destinations refer to sources and destinations external to the second device 541.

The second imaging interface 556 can include different implementations depending on which functional units or external units are being interfaced with the second imaging unit 546. The second imaging interface 556 can be implemented with technologies and techniques similar to the implementation of the first control interface 514.

The second device 541 can include a second communication unit 550. The second communication unit 550 can enable external communication to and from the second device 541. For example, the second communication unit 550 can permit the second device 541 to communicate with the first device 501, an attachment, such as a peripheral device or a computer desktop, and the communication link 530.

The second communication unit 550 can also function as a communication hub allowing the second device 541 to function as part of the communication link 530 and not limited to be an end point or terminal unit to the communication link 530. The second communication unit 550 can include active and passive components, such as microelectronics or an antenna, for interaction with the communication link 530.

The second communication unit 550 can include a second communication interface 560. The second communication interface 560 can be used for communication between the second communication unit 550 and other functional units in the second device 541. The second communication interface 560 can receive information from the other functional units or can transmit information to the other functional units.

The second communication interface 560 can include different implementations depending on which functional units are being interfaced with the second communication unit 550. The second communication interface 560 can be implemented with technologies and techniques similar to the implementation of the second control interface 554.

The second device 541 can include a second user interface 542. The second user interface 542 allows a user (not shown) to interface and interact with the second device 541. The second user interface 542 can include a second user input (not shown). The second user input can include touch screen, gestures, motion detection, buttons, slicers, knobs, virtual buttons, voice recognition controls, or any combination thereof.

The second user interface 542 can include a second display interface 543. The second display interface 543 can allow the user to interact with the second user interface 542. The second display interface 543 can include a display, a video screen, a speaker, or any combination thereof.

The second control unit 548 can operate with the second user interface 542 to display information generated by the video processing system 100 on the second display interface 543. The second control unit 548 can also execute the second software 552 for the other functions of the video processing system 100, including receiving display information from the second storage unit 544 for displaying on the second display interface 543. The second control unit 548 can further execute the second software 552 for interaction with the communication link 530 via the second communication unit 550.

For illustrative purposes, the second device 541 can be partitioned having the second user interface 542, the second storage unit 544, the second control unit 548, and the second communication unit 550, although it is understood that the second device 541 can have a different partition. For example, the second software 552 can be partitioned differently such that some or all of its function can be in the second control unit 548 and the second communication unit 550. In addition, the second device 541 can include other functional units not shown in FIG. 1 for clarity.

The first communication unit 510 can couple with the communication link 530 to send information to the second device 541 in the first device transmission 532. The second device 541 can receive information in the second communication unit 550 from the first device transmission 532 of the communication link 530.

The second communication unit 550 can couple with the communication link 530 to send video information to the first device 501 in the second device transmission 534. The first device 501 can receive video information in the first communication unit 510 from the second device transmission 534 of the communication link 530. The video processing system 100 can be executed by the first control unit 508, the second control unit 548, or a combination thereof.

The functional units in the first device 501 can work individually and independently of the other functional units. For illustrative purposes, the video processing system 100 is described by operation of the first device 501. It is understood that the first device 501 can operate any of the modules and functions of the video processing system 100. For example, the first device 501 can be described to operate the first control unit 508.

The functional units in the second device 541 can work individually and independently of the other functional units. For illustrative purposes, the video processing system 100 can be described by operation of the second device 541. It is understood that the second device 541 can operate any of the modules and functions of the video processing system 100. For example, the second device 541 is described to operate the second control unit 548.

For illustrative purposes, the video processing system 100 is described by operation of the first device 501 and the second device 541. It is understood that the first device 501 and the second device 541 can operate any of the modules and functions of the video processing system 100. For example, the first device 501 is described to operate the first control unit 508, although it is understood that the second device 541 can also operate the first control unit 508.

The video processing system 100 can include the first software 512 of the first device 501. The first control unit 508 can execute the first software 512 to receive the video bitstream 110. The video processing system 100 can include the second software 552 of the second device 541. The second control unit 548 can execute the second software 552 to receive the video bitstream 110. The video processing system 100 can be partitioned between the first software 512 and the second software 552.

In an illustrative example, the video processing system 100 can include the video encoder 102 on the first device 501 and the video decoder 104 on the second device 541. The video decoder 104 can include the display processor 118 of FIG. 1 and the display interface 50. Depending on the size of the first storage unit 504 of FIG. 9, the first software 512 can include additional modules of the video processing system 100.

The first control unit 508 can operate the first communication unit 510 of FIG. 9 to send the video bitstream 110 to the second device 541. The first control unit 508 can operate the first software 512 to operate the first imaging unit 506 of FIG. 9. The second communication unit 550 of FIG. 9 can send the video stream 112 to the first device 501 over the communication link 530.

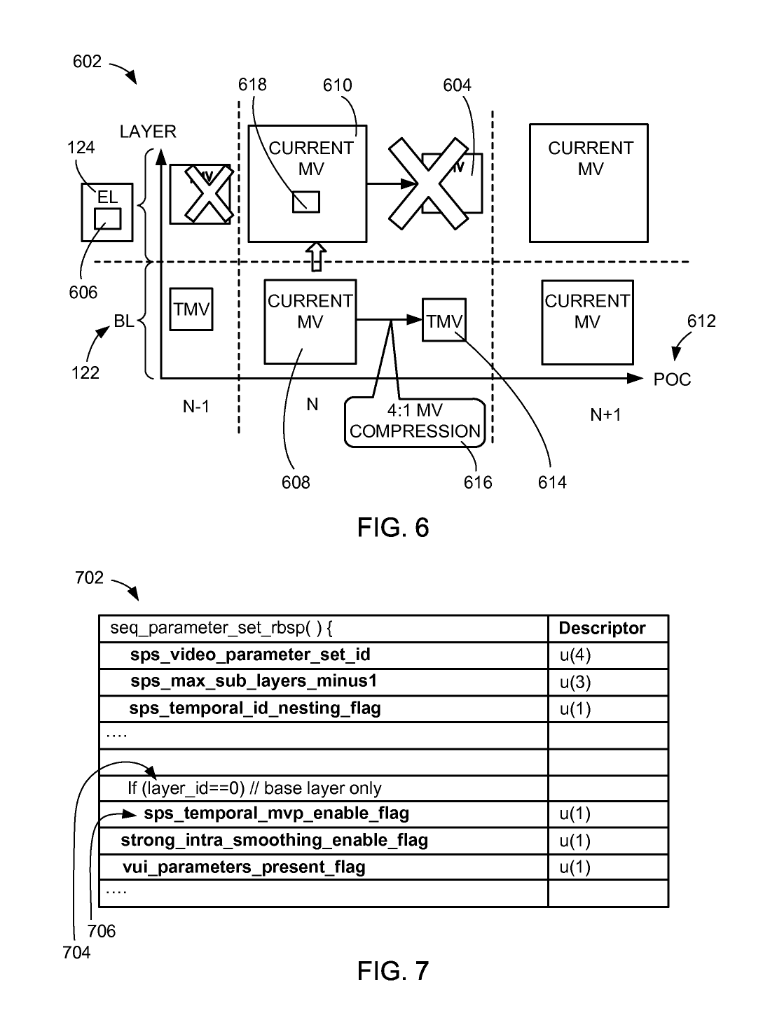

Referring now to FIG. 6, therein is shown an exemplary diagram illustrating an inter-layer motion vector prediction 602. The inter-layer motion vector prediction 602 is defined as a process of video compression that is used to represent a group of picture elements in a coded picture based on a position of the group in a reference picture, wherein the process employs information from a representation of pictures for another representation of the pictures.

FIG. 6 depicts a proposed algorithm for the inter-layer motion vector prediction 602. The proposed algorithm provides memory reduction for motion vector (MV) data of the enhancement layers 124 in Scalable High Efficiency Video Coding (SHVC).

The embodiments described herein proposes reduced memory for motion vector (MV) data of the enhancement layers 124 by removing an enhancement temporal motion vector 604 in a prediction candidate list 606. The enhancement temporal motion vector 604 is defined as a source for a motion vector coding method in the enhancement layers 124 that employs motion vectors for blocks in a video frame using motion vectors from blocks in another video frame to minimize residual between prediction and original motion vectors. A temporal motion vector is used to predict a motion vector of a current block.

The prediction candidate list 606 is defined as motion information associated with spatially or temporally neighboring blocks. The prediction candidate list 606 includes motion vectors for redundancy removal. The prediction candidate list 606 includes any number of motion vectors. The prediction candidate list 606 includes motion vectors that are calculated using spatial neighbors, temporal neighbors, or a combination thereof for deriving predictions.

The prediction candidate list 606 can include a merge motion vector (MV) candidate list or a motion vector predictor (MVP) candidate list. For example, the MVP candidate list can include an advanced motion vector prediction (AMVP) candidate list.

The prediction candidate list 606 can include a motion vector (MV) predictor list and a merge candidate list in the enhancement layers 124. For example, the enhancement layers 124 can be SHVC enhancement layers.

In the embodiments, potential performance drop can be compensated by using algorithms or methods of the inter-layer motion vector prediction 602. A proposed solution or the proposed algorithm is tested in combination with another inter-layer MV prediction proposed in JCTVC-K0037 for the Joint Collaborative Team on Video Coding (JCT-VC).

Simulation results are compared to the SHVC test Model under Consideration code version 0.1.1 (SMuC0.1.1) anchor, Bjontegaard Distortion-rate (BD-rate) numbers for the base layer 122 and the enhancement layers 124 in combination (BL+EL). The simulation results provided below are in Luma merge mode, AMVP, and both merge and AMVP.

The anchor is a method of measuring performance in the SMuC software. The simulation results measure performance of the proposed solution using the anchor in the SMuC software as a reference software or routine.

In the Luma merge mode, the simulation results show that the BD-rate numbers are −1.67% for random access (RA) 2×, −1.99% for RA 1.5×, −0.58% for low delay inter prediction (LP) 2×, and −0.67% for LP 1.5×. In the simulation results described herein, RA uses following frames for temporal prediction and low delay uses only previous frames for reference.

The terms “2×” and “1.5×” indicate base/enhancement layer spatial resolution ratios for spatial scalability. These terms refer to resolution ratios between the enhancement layers 124 and the base layer 122. For example, “2×” means that each dimension of the width and the height of the enhancement layers 124 is twice that of the base layer 122.

For AMVP, the BD-rate numbers for the BL+EL combination in the Luma merge mode are −1.98% for RA 2×, −2.24% for RA 1.5×, −0.93% for LP 2×, and −0.96% for LP 1.5×. For both the merge and AMVP, the BD-rate numbers for the BL+EL combination in the Luma merge mode are −1.92% for RA 2×, −2.20% for RA 1.5×, −0.86% for LP 2×, and −0.91% for LP 1.5×.

A base motion vector 608 of the base layer 122 can be used to predict an enhancement motion vector 610 of the enhancement layers 124. Several other inter-layer MV prediction algorithms are proposed in the 11th JCT-VC meeting and tested in the Tool Experiment 5 (TE5) Section 5.2. For example, the base motion vector 608 of the base layer 122 can be used to predict the enhancement motion vector 610 in SHVC.

The base motion vector 608 is defined as a motion estimation process used in the base layer 122 to represent a group of picture elements in an encoded picture based on a position of the group or a similar group in a reference picture. The enhancement motion vector 610 is defined as a motion estimation process used in the enhancement layers 124 to represent a group of picture elements in an encoded picture based on a position of the group or a similar group in a reference picture.

The another inter-layer MV prediction algorithm from JCTVC-K0037 and an SMuC0.1.1 example hook are demonstrated. In JCTVC-K0037, an MV compression process is performed after encoding and decoding of the enhancement layers 124.

An advantage of an approach of the embodiments is that the enhancement layers 124 can access a more accurate MV data from the base layer 122. An improved BD-rate is confirmed by results of TE5.

An idea of the embodiments is that, as shown in a TE5 report, the inter-layer motion vector prediction 602 can improve a coding performance. The enhancement layers 124 apply the proposed algorithm. For example, the proposed algorithm can include a MV prediction algorithm in HEVC.

The enhancement temporal motion vector 604 of the enhancement layers 124 is one of candidates for the prediction candidate list 606 including a merge list and an MV predictor list. Although a temporal MV is compressed to save or reduce storage capacity, a temporal MV size is still large given that the enhancement layers 124 include a large resolution.

To reduce the storage capacity of MV data for the enhancement layers 124 and achieve a better trade-off between memory usage and coding efficiency, it is proposed in the embodiments to remove the enhancement temporal motion vector 604. The enhancement temporal motion vector 604 is proposed to be removed from the prediction candidate list 606 for the enhancement layers 124.

Instead, the base motion vector 608 is added to the prediction candidate list 606. The inter-layer motion vector prediction 602 includes the base motion vector 608 added to the prediction candidate list 606 as shown in FIG. 6 by the vertical arrow pointing from the base layer 122 to the enhancement layers 124.

The proposed solution as described above is demonstrated in FIG. 6. In other words, the enhancement temporal motion vector 604 removed in the enhancement layers 124 is shown by the “X” labeled over a box representing the enhancement temporal motion vector 604.

Since the base motion vector 608 is added to the prediction candidate list 606 and the enhancement temporal motion vector 604 is removed, the total length of the prediction candidate list 606 stays or remains the same as that of HEVC. So no additional pruning or reduction in length is needed for the proposed solution. A length of the prediction candidate list 606 refers to a number of motion vectors included in the prediction candidate list 606.

No additional pruning or reduction in length is needed because the prediction candidate list 606 can include a limit of candidates. For example, the prediction candidate list 606 can include up to 5 candidates or motion vectors associated with the merge MV candidate list or up to 2 candidates or motion vectors associated with the AMVP candidate list. Thus, the total length of the prediction candidate list 606 can remain the same and so additional pruning is not needed resulting in no additional complexity.

As previously described, memory reduction is achieved in the enhancement layers 124. The memory reduction is achieved by disabling the enhancement temporal motion vector 604 for merge and MV prediction in the enhancement layers 124 but enabling the inter-layer motion vector prediction 602 using the base motion vector 608. The inter-layer motion vector prediction 602 including prediction in the base layer 122 using the base motion vector 608 compensates for loss of disabling the enhancement temporal motion vector 604 in the enhancement layers 124.

A pro or an argument in favor of the proposed solution is that there is an advantage of less or reduced memory usage. A BD performance drop is not large. However, this performance drop can be compensated by using algorithms or methods of the inter-layer motion vector prediction 602.

With the proposed solution, the base layer 122 and the enhancement layers 124 complete processing each picture or one of the frames 109 of FIG. 1. After that, the base layer 122 and the enhancement layers 124 store motion vectors for future usage but in smaller sizes for the motion vectors.

For example, the base motion vector 608 can be a current motion vector of one of the frames 109 that is being encoded. As a specific example, the base motion vector 608 can be a current motion vector of one of the frames 109 indicated by a picture order count 612 (POC), denoted by N−1, N, and N+1. The picture order count 612 is defined as a numerical value indicating which one of the frames 109 is being encoded.

The base layer 122 can include a base temporal motion vector 614, which is defined as information indicating transformation of a group of picture elements a reference picture to an encoded picture, where the transformation applies to the base layer 122. The base temporal motion vector 614 is a source for a motion vector coding method in the base layer 122 that employs motion vectors for blocks in a video frame using motion vectors from blocks in another video frame to minimize residual between prediction and original motion vectors.

For example, the base temporal motion vector 614 can provide a base compression ratio 616. As a specific example, the base temporal motion vector 614 can provide the base compression ratio 616 of 4:1 for one of the frames 109 being encoded in the base layer 122.

The base compression ratio 616 is defined as an amount of video data converted to reduce the number of bits in the base layer 122, thus allowing more efficient storage and transmission of the video data. In other words, the base compression ratio 616 indicates a ratio of uncompressed data over compressed data, where in the ratio is higher than 1 for video compression.

Upon completion of each of the frames 109, the base layer 122 stores the base motion vector 608 and the base temporal motion vector 614. The base motion vector 608 can be encoded by a temporal prediction method using the base temporal motion vector 614. The temporal prediction method refers to a coding process for motion vectors in a video frame by employing motion vectors from blocks in other video frames to minimize residual between prediction and original motion vectors.

Beside the base motion vector 608, the inter-layer motion vector prediction 602 includes the base temporal motion vector 614 used for predicting the enhancement motion vector 610. After the base motion vector 608 or the base temporal motion vector 614 is calculated, it is passed to the enhancement layers 124 to determine the enhancement motion vector 610.

When the base temporal motion vector 614 is used to determine the enhancement motion vector 610, the enhancement motion vector 610 can include an enhancement compression ratio 618. For example, the base temporal motion vector 614 can provide the base compression ratio 616. As a specific example, the enhancement motion vector 610 can include the enhancement compression ratio 618 of 4:1 for one of the frames 109 being encoded in the enhancement layers 124 based on the base temporal motion vector 614.

The enhancement compression ratio 618 is defined as an amount of video data converted to the number of bits in the enhancement layers 124, thus allowing more efficient storage and transmission of the video data. In other words, the enhancement compression ratio 618 indicates a ratio of uncompressed data over compressed data, where in the ratio is higher than 1 for video compression.

It has been found that the inter-layer motion vector prediction 602 including the base motion vector 608 and the base temporal motion vector 614 used for predicting the enhancement motion vector 610 eliminates storage memory for the enhancement temporal motion vector 604. It is understood that the inter-layer motion vector prediction 602 eliminates the storage memory without image quality degradation. It is also understood that the inter-layer motion vector prediction 602 provides improved coding efficiency.

Referring now to FIG. 7, therein is shown an example of a sequence parameter set syntax 702. The sequence parameter set syntax 702 is defined as information associated with video data. The sequence parameter set syntax 702 is denoted as “seq_parameter_set_rbsp”, where “seq” is sequence and “rbsp” is raw byte sequence payload.

For example, FIG. 7 depicts a proposal for a change to a working draft (WD) for HEVC. Also for example, the sequence parameter set syntax 702 can be applicable to a video stream sequence.

The sequence parameter set syntax 702 includes information that an encoder inserts in a video stream for a decoder to receive and decode video data from the video stream. Also for example, the sequence parameter set syntax 702 can include a resolution and a frame rate of video data.

The sequence parameter set syntax 702 includes a method for checking a layer identification 704, which is defined as information used for designation of an abstraction layer in video compression. The layer identification 704 is denoted as “layer_id”, where “id” is identification.

The layer identification 704 represents an identification of a network abstraction layer (NAL) unit header. The layer identification 704 can be used to identify a number of layers that may be present in a coded video sequence.

For example, the layer identification 704 of “0” can represent the base layer 122 of FIG. 1. Also for example, the layer identification 704 can be used to represent a spatial scalable layer, a quality scalable layer, a texture view, or a depth view.

The sequence parameter set syntax 702 includes a sequence temporal prediction enable flag 706, which is defined as an indicator for controlling whether or not a temporal motion vector is present or used in a picture. The sequence temporal prediction enable flag 706 is denoted as “sps_temporal_mvp_enable_flag”, where “sps” is sequence parameter set and “mvp” is motion vector prediction. The enhancement temporal motion vector 604 of FIG. 6 can be totally removed from the enhancement layers 124 of FIG. 1 by using a sequence parameter set (SPS) level flag or the sequence temporal prediction enable flag 706.

The method for checks if the layer identification 704 is set to “0”, which refers to only the base layer 122. In this case, the sequence parameter set syntax 702 includes the sequence temporal prediction enable flag 706.

The sequence temporal prediction enable flag 706 equal to “1” specifies that slice_temporal_mvp_enable_flag is present in slice headers of pictures with IdrPicFlag equal to “0” in a coded video sequence. “slice_temporal_mvp_enable_flag” and “IdrPicFlag” will be subsequently described below.

The sequence temporal prediction enable flag 706 equal to “0” specifies that slice_temporal_mvp_enable_flag is not present in slice headers and that temporal motion vector predictors are not used in a coded video sequence. When the sequence temporal prediction enable flag 706 is not present, the sequence temporal prediction enable flag 706 is set to “0”.

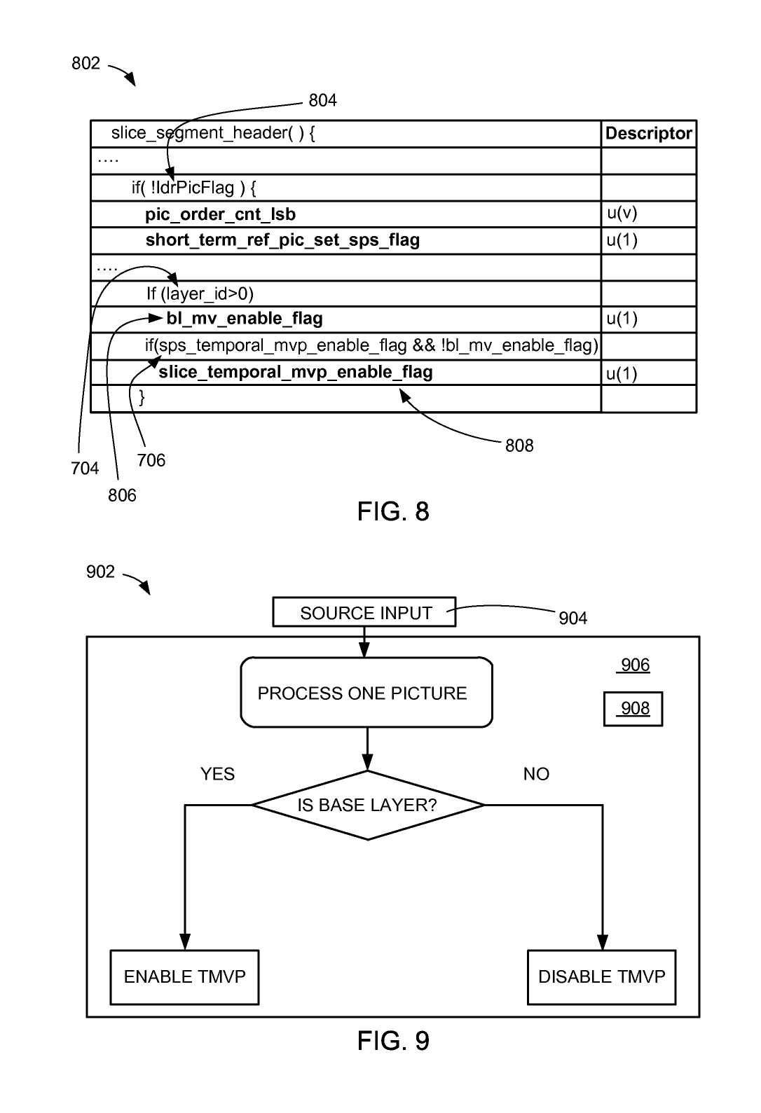

Referring now to FIG. 8, therein is shown an example of a slice segment header syntax 802. The slice segment header syntax 802 is defined as information associated with a portion of a number of coding blocks partitioned from a picture. The slice segment header syntax 802 is denoted as “slice segment header”. For example, the slice segment header syntax 802 can be information associated with an integer number of coding tree blocks ordered consecutively in a raster scan.

For example, FIG. 8 depicts a proposal for a change to a WD for HEVC. Also for example, the slice segment header syntax 802 can be applicable to a slice, which is an integer number of coding tree blocks ordered consecutively in a raster scan.

The slice segment header syntax 802 includes a method for checking an intra picture flag 804, which is defined as an indicator for controlling whether or not a current picture is a coded picture capable of being decoded without decoding any previous pictures. For example, the intra picture flag 804 can be an Instantaneous Decoder Refresh (IDR) picture flag, denoted as “IdrPicFlag”, where “Idr” is Instantaneous Decoder Refresh and “Pic” is picture.

For example, the intra picture flag 804 indicates whether a current picture is an Instantaneous Decoder Refresh (IDR) picture. This flag can be equal to “1” when the current picture is an IDR picture and can be equal to “0” when the current picture is not an IDR picture.

At the beginning of a coded video sequence is an instantaneous decoding refresh (IDR) access unit. The IDR access unit can include an intra picture, which is a coded picture that can be decoded without decoding any previous pictures in an NAL unit stream. The presence of the IDR access unit indicates that no subsequent pictures in the stream require reference to pictures prior to the intra picture it contains in order to be decoded. The NAL unit stream can contain one or more coded video sequences.

The slice segment header syntax 802 provides a new syntax that can be added to a video signal. The new syntax provides a usage of the base motion vector 608 of FIG. 6 or the base temporal motion vector 614 of FIG. 6 for the inter-layer motion vector prediction 602 of FIG. 6. The corresponding WD text changes are described below.

The method checks the intra picture flag 804. If the intra picture flag 804 is set to “0”, the method checks the layer identification 704. If the layer identification 704 includes a numerical value greater than “0”, which refers to a layer other than or higher than the base layer 122 of FIG. 1. For example, the layer identification 704 greater than “0” can indicate the enhancement layers 124 of FIG. 1.

When the layer identification 704 is greater than “0”, the slice segment header syntax 802 includes a base motion vector enable flag 806. The base motion vector enable flag 806 is defined as an indicator for controlling whether or not a motion vector or inter coding information from the base layer 122 is present or used in a picture slice. The base motion vector enable flag 806 is denoted as “bl_my_enable_flag”, where “bl” is base layer and “my” is motion vector.

The base motion vector enable flag 806 equals to “1” specifies that the inter-layer motion vector prediction 602 is used. The base motion vector enable flag 806 equals to “0” specifies that the inter-layer motion vector prediction 602 is not applied.

When the base motion vector enable flag 806 equals to “1”, a motion vector (MV) from a block co-located in the base layer 122 can be used and included in the prediction candidate list 606 of FIG. 6 including a merge mode candidate list and a motion vector (MV) prediction list. The motion vector from the block co-located in the base layer 122 can include the base motion vector 608 or the base temporal motion vector 614.

The method subsequently checks the sequence temporal prediction enable flag 706 and the base motion vector enable flag 806. If the sequence temporal prediction enable flag 706 is “1” and the base motion vector enable flag 806 is “0”, the slice segment header syntax 802 includes a slice temporal prediction enable flag 808, which is defined as an indicator for controlling whether or not a temporal motion vector is present or used in a slice in a picture. The slice temporal prediction enable flag 808 is denoted as “slice_temporal_mvp_enable_flag”, where “mvp” is motion vector prediction.

The slice temporal prediction enable flag 808 equals to “0” specifies that temporal motion vector predictors are not used in a coded video sequence. The slice temporal prediction enable flag 808 equals to “1” specifies that temporal motion vector predictors are used in a coded video sequence.

The slice temporal prediction enable flag 808 specifies whether temporal motion vector predictors can be used for inter prediction. If the slice temporal prediction enable flag 808 is equal to “0”, syntax elements of a current picture can be constrained such that no temporal motion vector predictor is used in decoding of the current picture.

Otherwise, if the slice temporal prediction enable flag 808 is equal to “1”, temporal motion vector predictors can be used in decoding of the current picture. When the slice temporal prediction enable flag 808 is not present, the value of the slice temporal prediction enable flag 808 is inferred to be equal to “0”.

Referring now to FIG. 9, therein is shown a control flow for a temporal motion vector control process 902. The temporal motion vector control process 902 is a process that activates an encoding method for inter-picture prediction for providing the temporal prediction mechanism.

The temporal motion vector control process 902 is used to enable a temporal motion vector prediction (TMVP). The temporal motion vector control process 902 is implemented in the video encoder 102 of FIG. 1.

The embodiments of the present invention introduce a condition in the temporal motion vector control process 902. For example, the condition can be used to enable or disable a tool in HEVC. A flowchart of the temporal motion vector control process 902 is described below.

The video processing system 100 of FIG. 1 includes a source input module 904 for receiving the frames 109 of FIG. 1 from the video source 108 of FIG. 1. The video processing system 100 includes the video stream 112 of FIG. 1. The video stream 112 can then be processed by other modules in the video encoder 102, some of which will be subsequently described below.

The video processing system 100 includes a picture process module 906 for processing a picture or one of the frames 109 at a time. The picture process module 906 processes the picture by encoding video data of the picture or the frames 109 as well as generating information associated with the picture including the sequence parameter set syntax 702 of FIG. 7 and the slice segment header syntax 802 of FIG. 8. The sequence parameter set syntax 702 and the slice segment header syntax 802 are generated as previously described in FIG. 7.

The picture process module 906 processes one picture or one of the frames 109 at a time. The picture process module 906 generates the base motion vector 608 of FIG. 6 and the base temporal motion vector 614 of FIG. 6 for the base layer 122 of FIG. 1. The picture process module 906 generates the enhancement motion vector 610 of FIG. 6 based on the base motion vector 608 or the base temporal motion vector 614 using the inter-layer motion vector prediction 602 of FIG. 6 to eliminate storage memory or a storage capacity 908 for the enhancement temporal motion vector 604 of FIG. 6.

In order to increase coding efficiency, the prediction candidate list 606 of FIG. 6 of the enhancement temporal motion vector 604 of the enhancement layers 124 of FIG. 1 is disabled to eliminate the storage capacity 908 for the enhancement temporal motion vector 604 in the enhancement layers 124. The enhancement temporal motion vector 604 is removed from the prediction candidate list 606 and the base motion vector 608 and the base temporal motion vector 614 are added to the prediction candidate list 606. The storage capacity 908 is defined as a size of a memory component for storing information.

In other words, prediction using a reference picture is disabled as it consumes more memory. Hence, motion vectors (MV) of the base layer 122, including the base motion vector 608 and the base temporal motion vector 614, is used to predict the enhancement motion vector 610 for the enhancement layers 124. More precisely, the inter-layer motion vector prediction 602 is used for predicting motion vectors in the enhancement layers 124.

The picture process module 906 generates the sequence parameter set syntax 702 by comparing the layer identification 704 of FIG. 7. If the layer identification 704 equals to “0” for indicating or identifying that a layer being processed or encoded is the base layer 122, the picture process module 906 generates the sequence temporal prediction enable flag 706 of FIG. 7 and sets it to “1” to enable the temporal motion vector predictors in the coded video sequence. If the layer identification 704 equals to “0” for indicating the layer being processed or encoded is not the base layer 122, the picture process module 906 generates the sequence temporal prediction enable flag 706 and sets it to “0” to disable the temporal motion vector predictors in the coded video sequence.

The picture process module 906 inserts the sequence temporal prediction enable flag 706 into the sequence parameter set syntax 702. For example, the layer being processed or encoded can be a network abstraction layer (NAL).

The picture process module 906 also generates the slice segment header syntax 802 by comparing the intra picture flag 804 of FIG. 8, the layer identification 704, the sequence temporal prediction enable flag 706, and the base motion vector enable flag 806 of FIG. 8. If the intra picture flag 804 is set to “0” indicating or identifies that the current picture or one of the frames 109 being processed is not an IDR picture, the picture process module 906 compares the layer identification 704.

If the layer identification 704 is greater than “0” for indicating or identifies that the layer being processed or encoded is not the base layer 122, the picture process module 906 generates the base motion vector enable flag 806 and sets it to “1”. The picture process module 906 inserts the base motion vector enable flag 806 into the slice segment header syntax 802.

The picture process module 906 then compares the sequence temporal prediction enable flag 706 and the base motion vector enable flag 806. If the sequence temporal prediction enable flag 706 is “1” and the base motion vector enable flag 806 is “0”, the picture process module 906 generates the slice temporal prediction enable flag 808 of FIG. 8 and sets it to “1”. The picture process module 906 inserts the slice temporal prediction enable flag 808 into the slice segment header syntax 802.

The source input module 904 and the picture process module 906 can be implemented in the video encoder 102 for generating the video bitstream 110 of FIG. 1 for the video decoder 104 of FIG. 1 to receive and decode. The video decoder 104 can generate the video stream 112 for displaying on a device such as the display interface 120 of FIG. 1.

The video bitstream 110 can be generated with information generated based on the inter-layer motion vector prediction 602. The video bitstream 110 can include but not limited to the base motion vector 608, the enhancement motion vector 610, the sequence parameter set syntax 702, and the slice segment header syntax 802.

Simulation has been performed for the proposed solution. The simulation of the proposed solution is implemented in the software of Tool Experiment 5 (TE5) 5.2.3. The implementation disables the enhancement temporal motion vector 604 for the enhancement layers 124 in the prediction candidate list 606 including both a merge list and an AMVP list in software directly.

Note that the implementation does not include WD changes previously described in FIGS. 8-9. Therefore, simulation results do not exactly reflect the WD changes. It is believed that the WD changes do not affect the peak signal-to-noise ratio (PSNR) but the bit-rate slightly. Simulations are conducted using configurations suggested in TE5. Running time is not available because simulations are run in a cluster. Simulation is performed using Class A and Class B test sequences with different resolution videos from each other.

In a case of random access (RA) HEVC 2×, the simulation results for merge only show that Bjontegaard Distortion-rate (BD-rate) numbers for Y, U, and V are −2.20%, −5.19%, and −4.94%, respectively, for Class A test sequences. The simulation results show that BD-rate numbers for Y, U, and V are −1.46%, −3.48%, and −3.58%, respectively, for Class B test sequences. Overall results for a combination of the enhancement layers 124 and the base layer 122 show that BD-rate numbers for Y, U, and V are −1.67%, −3.97%, and −3.97%, respectively. Overall results for the enhancement layers 124 show that BD-rate numbers for Y, U, and V are −3.36%, −7.36%, and −7.42%, respectively. In this case, the simulation results show that the output of the base layer 122 matches reference images including a single layer of HEVC version 1.

In a case of RA HEVC 1.5×, the simulation results for merge only show that BD-rate numbers for Y, U, and V are −1.99%, −3.72%, and −4.03%, respectively, for Class B test sequences. Overall results for a combination of the enhancement layers 124 and the base layer 122 show that BD-rate numbers for Y, U, and V are −1.99%, −3.72%, and −4.03%, respectively. Overall results for the enhancement layers 124 show that BD-rate numbers for Y, U, and V are −5.46%, −9.32%, and −10.04%, respectively. In this case, the simulation results show that the output of the base layer 122 matches reference images including a single layer of HEVC version 1.

The terms “2×” and “1.5×” indicate base/enhancement layer spatial resolution ratios for spatial scalability. These terms refer to resolution ratios between the enhancement layers 124 and the base layer 122. For example, “2×” means that each dimension of the width and the height of the enhancement layers 124 is twice that of the base layer 122.

In a case of low delay profile (LD-P) HEVC 2×, the simulation results for merge only show that BD-rate numbers for Y, U, and V are −1.13%, −2.79%, and −2.55%, respectively, for Class A test sequences. The simulation results show that BD-rate numbers for Y, U, and V are −0.36%, −1.86%, and −1.90%, respectively, for Class B test sequences. Overall results for a combination of the enhancement layers 124 and the base layer 122 show that BD-rate numbers for Y, U, and V are −0.58%, −2.12%, and −2.08%, respectively. Overall results for the enhancement layers 124 show that BD-rate numbers for Y, U, and V are −1.22%, −3.77%, and −3.67%, respectively. In this case, the simulation results show that the output of the base layer 122 matches reference images including a single layer of HEVC version 1.

In a case of LD-P HEVC 1.5×, the simulation results for merge only show that BD-rate numbers for Y, U, and V are −0.67%, −1.89%, and −2.05%, respectively, for Class B test sequences. Overall results for a combination of the enhancement layers 124 and the base layer 122 show that BD-rate numbers for Y, U, and V are −0.67%, −1.89%, and −2.05%, respectively. Overall results for the enhancement layers 124 show that BD-rate numbers for Y, U, and V are −1.69%, −4.07%, and −4.35%, respectively. In this case, the simulation results show that the output of the base layer 122 matches reference images including a single layer of HEVC version 1.

In a case of RA HEVC 2×, the simulation results for AMVP only show that BD-rate numbers for Y, U, and V are −2.55%, −5.55%, and −5.30%, respectively, for Class A test sequences. The simulation results show that BD-rate numbers for Y, U, and V are −1.75%, −3.76%, and −3.86%, respectively, for Class B test sequences. Overall results for a combination of the enhancement layers 124 and the base layer 122 show that BD-rate numbers for Y, U, and V are −1.98%, −4.27%, and −4.27%, respectively. Overall results for the enhancement layers 124 show that BD-rate numbers for Y, U, and V are −3.88%, −7.84%, and −7.89%, respectively. In this case, the simulation results show that the output of the base layer 122 matches reference images including a single layer of HEVC version 1.

In a case of RA HEVC 1.5×, the simulation results for AMVP only show that BD-rate numbers for Y, U, and V are −2.24%, −3.91%, and −4.23%, respectively, for Class B test sequences. Overall results for a combination of the enhancement layers 124 and the base layer 122 show that BD-rate numbers for Y, U, and V are −2.24%, −3.91% and −4.23%, respectively. Overall results for the enhancement layers 124 show that BD-rate numbers for Y, U, and V are −6.02%, −9.68%, and −10.44%, respectively. In this case, the simulation results show that the output of the base layer 122 matches reference images including a single layer of HEVC version 1.

In a case of LD-P HEVC 2×, the simulation results for AMVP only show that BD-rate numbers for Y, U, and V are −1.55%, −3.26%, and −3.09%, respectively, for Class A test sequences. The simulation results show that BD-rate numbers for Y, U, and V are −0.68%, −2.22%, and −2.30%, respectively, for Class B test sequences. Overall results for a combination of the enhancement layers 124 and the base layer 122 show that BD-rate numbers for Y, U, and V are −0.93%, −2.52%, and −2.52%, respectively. Overall results for the enhancement layers 124 show that BD-rate numbers for Y, U, and V are −1.77%, −4.36%, and −4.34%, respectively. In this case, the simulation results show that the output of the base layer 122 matches reference images including a single layer of HEVC version 1.

In a case of LD-P HEVC 1.5×, the simulation results for AMVP only show that BD-rate numbers for Y, U, and V are −0.96%, −2.11%, and −2.37%, respectively, for Class B test sequences. Overall results for a combination of the enhancement layers 124 and the base layer 122 show that BD-rate numbers for Y, U, and V are −0.96%, −2.11%, and −2.37%, respectively. Overall results for the enhancement layers 124 show that BD-rate numbers for Y, U, and V are −2.26%, −4.49%, and −5.01%, respectively. In this case, the simulation results show that the output of the base layer 122 matches reference images including a single layer of HEVC version 1.

In a case of RA HEVC 2×, the simulation results for merge and AMVP show that BD-rate numbers for Y, U, and V are −2.47%, −5.52%, and −5.28%, respectively, for Class A test sequences. The simulation results show that BD-rate numbers for Y, U, and V are −1.70%, −3.76%, and −3.89%, respectively, for Class B test sequences. Overall results for a combination of the enhancement layers 124 and the base layer 122 show that BD-rate numbers for Y, U, and V are −1.92%, −4.26%, and −4.29%, respectively. Overall results for the enhancement layers 124 show that BD-rate numbers for Y, U, and V are −3.79%, −7.82%, and −7.91%, respectively. In this case, the simulation results show that the output of the base layer 122 matches reference images including a single layer of HEVC version 1.

In a case of RA HEVC 1.5×, the simulation results for merge and AMVP show that BD-rate numbers for Y, U, and V are −2.20%, −3.89%, and −4.23%, respectively, for Class B test sequences. Overall results for a combination of the enhancement layers 124 and the base layer 122 show that BD-rate numbers for Y, U, and V are −2.20%, −3.89%, and −4.23%, respectively. Overall results for the enhancement layers 124 show that BD-rate numbers for Y, U, and V are −5.93%, −9.65%, and −10.44%, respectively. In this case, the simulation results show that the output of the base layer 122 matches reference images including a single layer of HEVC version 1.

In a case of LD-P HEVC 2×, the simulation results for merge and AMVP show that BD-rate numbers for Y, U, and V are −1.48%, −3.18%, and −3.04%, respectively, for Class A test sequences. The simulation results show that BD-rate numbers for Y, U, and V are −0.62%, −2.21%, and −2.29%, respectively, for Class B test sequences. Overall results for a combination of the enhancement layers 124 and the base layer 122 show that BD-rate numbers for Y, U, and V are −0.86%, −2.48%, and −2.51%, respectively. Overall results for the enhancement layers 124 show that BD-rate numbers for Y, U, and V are −1.66%, −4.29%, and −4.29%, respectively. In this case, the simulation results show that the output of the base layer 122 matches reference images including a single layer of HEVC version 1.

In a case of LD-P HEVC 1.5×, the simulation results for merge and AMVP show that BD-rate numbers for Y, U, and V are −0.91%, −2.09%, and −2.29%, respectively, for Class B test sequences. Overall results for a combination of the enhancement layers 124 and the base layer 122 show that BD-rate numbers for Y, U, and V are −0.91%, −2.09%, and −2.29%, respectively. Overall results for the enhancement layers 124 show that BD-rate numbers for Y, U, and V are −2.18%, −4.44%, and −4.79%, respectively. In this case, the simulation results show that the output of the base layer 122 matches reference images including a single layer of HEVC version 1.

Performance results of the proposed solution are as follows. Based on a Realistic Media Research Team's (ETRI's) proposal in TE5-5.2.3, performance drops of the proposed solution are 0.3%-0.5% as expected. Tests are performed for Y-RA-2×, Y-RA-1.5×, Y-RA-SNR, Y-LDP-1.5×, Y-LDP-2×, and Y-LDP-SNR, where “Y” is the luminance component, “RA” is random access, “SNR” is signal-to-noise ratio, and “LDP” is low delay profile configurations. Results of tests performed are reported as follows.

For ETRI vs. SMuC0.1.1, tests performed for merge only show that BD-rate numbers for Y-RA-2×, Y-RA-1.5×, Y-LDP-1.5×, and Y-LDP-2× are −2.20, −2.30, −1.24, and −1.20, respectively. Tests performed for AMVP only show that BD-rate numbers for Y-RA-2×, Y-RA-1.5×, Y-LDP-1.5×, and Y-LDP-2× are −1.55, −1.52, −0.97, and −0.83, respectively. Tests performed for merge and AMVP show that BD-rate numbers for Y-RA-2×, Y-RA-1.5×, Y-RA-SNR, Y-LDP-1.5×, Y-LDP-2×, and Y-LDP-SNR are −2.36, −2.46, −2.57, −1.31, −1.26, and −2.03, respectively.

For the proposed solution vs. SMuC0.1.1, tests performed for merge only show that BD-rate numbers for Y-RA-2×, Y-RA-1.5×, Y-LDP-1.5×, and Y-LDP-2× are −1.67, −1.99, −0.67, and −0.58, respectively. Tests performed for merge and AMVP show that BD-rate numbers for Y-RA-2×, Y-RA-1.5×, Y-LDP-1.5×, and Y-LDP-2× are −1.92, −2.20, −0.91, and −0.86, respectively. As a result, BD-rate numbers of the proposed solution are lower than those of ETRI.

In conclusion, a solution for the inter-layer motion vector prediction 602 with reduced memory is proposed in this contribution. Simulation results show coding efficiency improvement without additional temporal MV storage in the enhancement layers 124. It is recommended to investigate the proposed solution under Core Experiment (CE) or Ad Hoc Group (AHG).

It has been found that the encoding the frames 109 with the inter-layer motion vector prediction 602 by generating the enhancement motion vector 610 based on the base motion vector 608 and the base temporal motion vector 614 to eliminate the storage capacity 908 for the enhancement temporal motion vector 604 provides improved coding efficiency.

It has also been found that encoding the frames 109 by generating the sequence parameter set syntax 702 and the slice segment header syntax 802 provides improved coding efficiency for generating the enhancement motion vector 610.

Functions or operations of the video encoder 102 in the video processing system 100 as described above can be implemented using modules. The functions or the operations of the video encoder 102 can be implemented in hardware, software, or a combination thereof. The modules can be implemented using the first user interface 502 of FIG. 5, the first storage unit 504 of FIG. 5, the first imaging unit 506 of FIG. 5, the first control unit 508 of FIG. 5, the first communication unit 510 of FIG. 5, or a combination thereof.

For example, the source input module 904 can be implemented with the first user interface 502, the first storage unit 504, the first imaging unit 506, and the first control unit 508 for receiving the frames 109 from the video source 108. Also for example, the picture process module 906 can be implemented with the first storage unit 504, the first imaging unit 506, and the first control unit 508 for encoding the frames 109 with the inter-layer motion vector prediction 602.

Further, for example, the picture process module 906 can be implemented with the first storage unit 504, the first imaging unit 506, and the first control unit 508 for generating the base motion vector 608 and the enhancement motion vector 610. Yet further, for example, the picture process module 906 can be implemented with the first storage unit 504, the first imaging unit 506, and the first control unit 508 for generating the video bitstream 110 based on the base motion vector 608 and the enhancement motion vector 610.

The video processing system 100 is described with module functions or order as an example. The modules can be partitioned differently. Each of the modules can operate individually and independently of the other modules.

Furthermore, data generated in one module can be used by another module without being directly coupled to each other. Yet further, the modules can be implemented as hardware accelerators (not shown) within the first control unit 508 or the second control unit 548 of FIG. 5, or can be implemented as hardware accelerators (not shown) in the video encoder 102 or outside of the video encoder 102. The source input module 904 can be coupled to the picture process module 906.

The physical transformation of encoding the frames 109 with the inter-layer motion vector prediction 602 to generating the video bitstream 110 for the video decoder 104 to receive and decode for displaying on the device results in movement in the physical world, such as people using the video encoder 102 and the video decoder 104 based on the operation of the video processing system 100. As the movement in the physical world occurs, the movement itself creates additional information that is converted back to receiving the frames 109 from the video source 108 for the continued operation of the video processing system 100 and to continue the movement in the physical world.

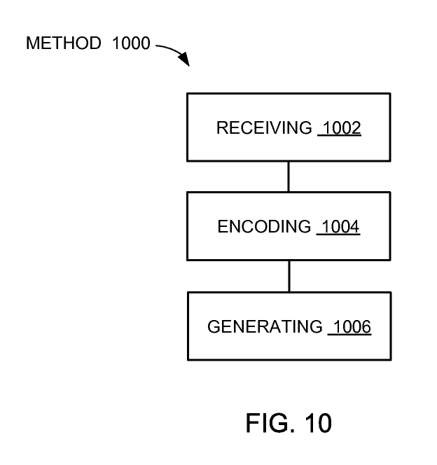

Referring now to FIG. 10, therein is shown a flow chart of a method 1000 of operation of a video processing system in a further embodiment of the present invention. The method 1000 includes: receiving a frame from a video source in a block 1002; encoding the frame with an inter-layer motion vector prediction by generating a base motion vector of a base layer and an enhancement motion vector of an enhancement layer based on the base motion vector to eliminate a storage capacity for an enhancement temporal motion vector in the enhancement layer in a block 1004; and generating a video bitstream based on the base motion vector and the enhancement motion vector for a video decoder to receive and decode for displaying on a device in a block 1006.

Thus, it has been discovered that the video processing system 100 of FIG. 1 of the present invention furnishes important and heretofore unknown and unavailable solutions, capabilities, and functional aspects for a video processing system with temporal prediction mechanism. The resulting method, process, apparatus, device, product, and/or system is straightforward, cost-effective, uncomplicated, highly versatile, accurate, sensitive, and effective, and can be implemented by adapting known components for ready, efficient, and economical manufacturing, application, and utilization.

Another important aspect of the present invention is that it valuably supports and services the historical trend of reducing costs, simplifying systems, and increasing performance.

These and other valuable aspects of the present invention consequently further the state of the technology to at least the next level.

While the invention has been described in conjunction with a specific best mode, it is to be understood that many alternatives, modifications, and variations will be apparent to those skilled in the art in light of the aforegoing description. Accordingly, it is intended to embrace all such alternatives, modifications, and variations that fall within the scope of the included claims. All matters hithertofore set forth herein or shown in the accompanying drawings are to be interpreted in an illustrative and non-limiting sense.

What is claimed is:

1. A method of operation of a video processing system comprising:
receiving a frame from a video source;
encoding the frame with an inter-layer motion vector prediction by generating a base motion vector of a base layer and an enhancement motion vector of an enhancement layer based on the base motion vector to eliminate a storage capacity for an enhancement temporal motion vector in the enhancement layer; and
generating a video bitstream based on the base motion vector and the enhancement motion vector for a video decoder to receive and decode for displaying on a device.

2. The method as claimed in claim 1 wherein encoding the frame includes encoding the frame by generating a base temporal motion vector of the base layer and the enhancement motion vector based on the base temporal motion vector.

3. The method as claimed in claim 1 wherein encoding the frame includes encoding the frame by removing the enhancement temporal motion vector from a prediction candidate list and add the base motion vector to the prediction candidate list.

4. The method as claimed in claim 1 wherein:
encoding the frame includes encoding the frame by generating a sequence parameter set syntax; and
generating the video bitstream includes generating the video bitstream with the sequence parameter set syntax.

5. The method as claimed in claim 1 wherein:
encoding the frame includes encoding the frame by generating a slice segment header syntax; and
generating the video bitstream includes generating the video bitstream with the slice segment header syntax.

6. A method of operation of a video processing system comprising:
receiving a frame from a video source;
encoding the frame with an inter-layer motion vector prediction by generating a base motion vector of a base layer and an enhancement motion vector of an enhancement layer based on the base motion vector to eliminate a storage capacity for an enhancement temporal motion vector in the enhancement layer; and
generating a video bitstream based on the base motion vector, the enhancement motion vector, a sequence parameter set syntax, and a slice segment header syntax for a video decoder to receive and decode for displaying on a device.

7. The method as claimed in claim 6 wherein encoding the frame includes encoding the frame by generating a base temporal motion vector of the base layer and the enhancement motion vector based on the base temporal motion vector, the base temporal motion vector having a base compression ratio of 4:1 in the base layer.

8. The method as claimed in claim 6 wherein encoding the frame includes encoding the frame by removing the enhancement temporal motion vector from a prediction candidate list and add the base motion vector to the prediction candidate list, the prediction candidate list includes a merge motion vector candidate list or an advanced motion vector prediction candidate list.

9. The method as claimed in claim 6 wherein encoding the frame includes encoding the frame by generating the sequence parameter set syntax based on a layer identification and a sequence temporal prediction enable flag, the sequence temporal prediction enable flag is enabled when the layer identification identifies the base layer.

10. The method as claimed in claim 6 wherein encoding the frame includes encoding the frame by generating the slice segment header syntax based on an intra picture flag, a layer identification, a sequence temporal prediction enable flag, a base motion vector enable flag, and a slice temporal prediction enable flag, the slice temporal prediction enable flag is enabled when the intra picture flag does not identify an Instantaneous Decoder Refresh picture, the layer identification does not identify the base layer, the sequence temporal prediction enable flag is enabled, and the base motion vector enable flag is not enabled.

11. A video processing system comprising:
a source input module for receiving a frame from a video source; and
a picture process module, coupled to the source input module, for encoding the frame with an inter-layer motion vector prediction by generating a base motion vector of a base layer and an enhancement motion vector of an enhancement layer based on the base motion vector to eliminate a storage capacity for an enhancement temporal motion vector in the enhancement layer and for generating a video bitstream based on the base motion vector and the enhancement motion vector for a video decoder to receive and decode for displaying on a device.

12. The system as claimed in claim 11 wherein the picture process module is for encoding the frame by generating a base temporal motion vector of the base layer and the enhancement motion vector based on the base temporal motion vector.

13. The system as claimed in claim 11 wherein the picture process module is for encoding the frame by removing the enhancement temporal motion vector from a prediction candidate list and add the base motion vector to the prediction candidate list.

14. The system as claimed in claim 11 wherein the picture process module is for encoding the frame by generating a sequence parameter set syntax and generating the video bitstream with the sequence parameter set syntax.

15. The system as claimed in claim 11 wherein the picture process module is for encoding the frame by generating a slice segment header syntax and generating the video bitstream with the slice segment header syntax.

16. The system as claimed in claim 11 wherein the picture process module is for generating the video bitstream based on a sequence parameter set syntax and a slice segment header syntax.

17. The system as claimed in claim 16 wherein the picture process module is for encoding the frame by generating a base temporal motion vector of the base layer and the enhancement motion vector based on the base temporal motion vector, the base temporal motion vector having a base compression ratio of 4:1 in the base layer.

18. The system as claimed in claim 16 wherein the picture process module is for encoding the frame by removing the enhancement temporal motion vector from a prediction candidate list and add the base motion vector to the prediction candidate list, the prediction candidate list includes a merge motion vector candidate list or an advanced motion vector prediction candidate list.

19. The system as claimed in claim 16 wherein the picture process module is for encoding the frame by generating the sequence parameter set syntax based on a layer identification and a sequence temporal prediction enable flag, the sequence temporal prediction enable flag is enabled when the layer identification identifies the base layer.

20. The system as claimed in claim 16 wherein the picture process module is for encoding the frame by generating the slice segment header syntax based on an intra picture flag, a layer identification, a sequence temporal prediction enable flag, a base motion vector enable flag, and a slice temporal prediction enable flag, the slice temporal prediction enable flag is enabled when the intra picture flag does not identify an Instantaneous Decoder Refresh picture, the layer identification does not identify the base layer, the sequence temporal prediction enable flag is enabled, and the base motion vector enable flag is not enabled.
